(19) United States
(12) Patent Application Publication
(10) Pub. No.: US 2021/0242695 A1
(43) Pub. Date: Aug. 5, 2021

(54) Wireless Charging System

(71) Applicants: Ardalan Zadehsoltan, Vancouver (CA); Amir Reza Ghassemi Gangan, Vancouver (CA)

(72) Inventors: Ardalan Zadehsoltan, Vancouver (CA); Amir Reza Ghassemi Gangan, Vancouver (CA)

(21) Appl. No.: 16/782,551

(22) Filed: Feb. 5, 2020

(51) Int. Cl. H02J 7/00; H04B 5/00; H02J 50/70

(52) U.S. Cl. CPC H02J 7/0044; H02J 50/70; H04B 5/0037

(57) ABSTRACT

A wireless charging system. The wireless charging system provides a wireless charging case for protecting, transporting, and charging a wireless pairable charging device. The wireless pairable charging device is able to charge a portable electronic device, such as a laptop. The wireless charging case has a housing that includes a slot for receiving the wireless pairable charging device and transmits power thereto via induction charging. The wireless pairable charging device includes a male charging port for directly connecting to the portable electronic device. The wireless charging case and the wireless pairable charging device each can wirelessly communicate with a companion electronic device to display the pairable charging device battery information and the case battery information.

### BACKGROUND OF THE INVENTION

The present invention relates to a wireless charging system. More specifically, the present invention relates to a wireless charging system having a wireless charging case and a wireless pairable charging device. The wireless charging case is adapted for protecting, transporting, and charging the wireless pairable charging device. The wireless pairable charging device is adapted for charging a portable electronic device, such as a laptop.

Mobile devices are part of a person's daily routine, such as like mobile phones, laptops, cameras and the like, and each mobile device requires regular charging of their batteries for continuous operation. Charging occurs through connecting electrical cables from wall outlets directly to the electronic device, or though wireless charging by placing the electronic device atop a wireless docking station. However, since charging is primarily accomplished through a long cable wired between a charger and a device, users suffer from inconvenience due to the limitation on cord length and the general distance between a user and a charging station. However, when the wireless charging method is desired to be applied to an electronic device, variation of charging efficiency occurs based on the position of the electronic device or the battery atop the docking station. Moreover, these wireless methods require both the electronic device and the docking station to include elements adapted for wireless charging which adds weight and cost to both.

Known charging systems are unable to provide solutions to existing problems associated with wired and wireless charging systems. For example, external batteries for charging certain electronic devices, such as a cell phone, provide limited charging power to a specific electronic device. Moreover, a known power bank requires direct cord charging with an external power source to recharge the power bank battery. The power bank is unable to wirelessly charge via a wireless charging case.

There exists a need for a wireless charging system that provides a wireless charging case that is adapted to house multiple wireless pairable charging devices. In this way, when the wireless pairable charging device requires a recharge, the wireless pairable charging device may be charged wirelessly within the case and a second or third wireless pairable charging device may be utilized on the same or alternative electronic device, without requiring a direct wired connection to an external power source, such as a wall outlet.

Consequently, there exists in the art a long felt need for a wireless charging system to allow a user to charge multiple electronic devices via the wireless pairable charging devices from home, office, or vehicle without connecting or disconnecting any wire, and to charge the wireless pairable charging devices from home, office, or vehicle without connecting or disconnecting any wire.

In light of the devices disclosed in the known art, it is submitted that the present invention substantially diverges in design elements and methods from the known art and consequently it is clear that there is a need in the art for an improvement for a wireless charging system and method of use. In this regard the instant invention substantially fulfills these needs.

### SUMMARY OF THE INVENTION

In view of the foregoing disadvantages inherent in the known types of wireless charging system now present in the known art. The present invention provides a new wireless charging system having a wireless charging case that is adapted to house and charge a wireless pairable charging device, wherein the wireless pairable charging device in turn provides wireless charging of a portable electronic device.

It is an objective of the present invention to provide an embodiment of the wireless charging system comprising a wireless case having a housing configured to receive one or more of the wireless pairable charging device, wherein the housing includes one or more slots adapted to receive the wireless pairable charging device. Moreover, each slot is adapted to inductively charge the wireless pairable charging device received therein.

It is another objective of the present invention to provide an embodiment of the wireless charging system comprising a wireless case having a lid attached to the housing and operable between a closed position such that a user cannot remove the wireless pairable charging device from the case.

It is an objective of the present invention to provide an embodiment of the wireless charging system comprising a wireless charging case having protection to the wireless pairable charging device when the wireless pairable charging device is placed within the case.

It is an objective of the present invention to provide an embodiment of the wireless charging system comprising a wireless charging case having a wireless charging contact configured to couple to the wireless pairable charging device when the wireless pairable charging device is placed within the housing.

It is an objective of the present invention to provide an embodiment of the wireless charging system comprising a wireless charging case having a wireless communication circuitry operably configured to transmit charging data of the wireless charging case battery and data communications circuitry configured to transmit firmware data and charging data to a portable electronic device.

It is another objective of the present invention to provide an embodiment of the wireless charging system comprising the wireless pairable charging device having a male charging port operably connected to the rechargeable battery and disposed on a side of a body, wherein the male charging port adapted to removably insert into a portable electronic device and provide electrical charge to the portable electronic device.

It is another objective of the present invention to provide an embodiment of the wireless charging system comprising the wireless pairable charging device having a female charging port operably connected to the rechargeable battery and disposed on a side of a body, the female charging port configured to receive a charging connector therein and thereby charge the wireless pairable charging device

It is therefore an object of the present invention to provide a new and improved wireless charging system that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a wireless charging case for protecting, transporting, and charging a wireless pairable charging device.

FIG. 2 shows a perspective view of an embodiment of the wireless charging system, wherein a wireless charging case receiving a wireless pairable charging device.

FIG. 3 shows a perspective view of an embodiment of a wireless pairable charging device being connected to a portable electronic device.

FIG. 4 shows a transparent side view of an embodiment of the wireless charging case receiving the wireless pairable charging device.

FIG. 5 shows a block diagram of an embodiment of the wireless pairable charging device disposed within the wireless charging case.

FIG. 6 shows a front view of one embodiment of a graphical user interface of a companion communication device operably connected to the wireless pairable charging device and the wireless charging case.

### DETAILED DESCRIPTION OF THE INVENTION

Reference is made herein to the attached drawings. Like reference numerals are used throughout the drawings to depict like or similar elements of the wireless charging system. For the purposes of presenting a brief and clear description of the present invention, the preferred embodiment will be discussed as used for protecting, transporting, and charging a wireless pairable charging device that includes a rechargeable battery, and for charging a portable electronic device from the wireless pairable charging device. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

References to “wireless” is defined as “using radio, microwaves, etc. (as opposed to wires or cables) to transmit signal.” Further, this definition is not necessarily limited to the listed description, Additionally, “wireless” includes “cordless” which can be defined as “an electrical appliance working without connection to a main power supply or central unit.” References to “wireless pairable charging device” is thereby encompassing of “cordless.” Additionally, use of “female” and “male” ports are references to types of connectors and may be used interchangeably with each other and is not necessarily limited to the listed description.

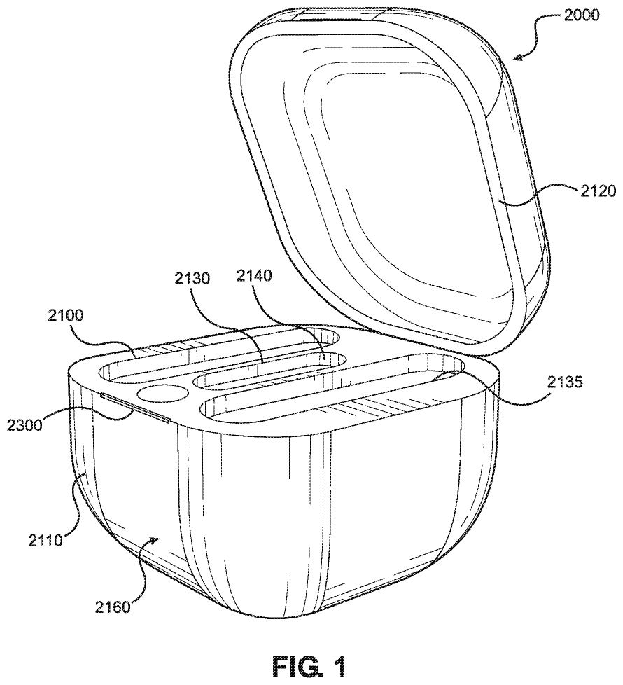

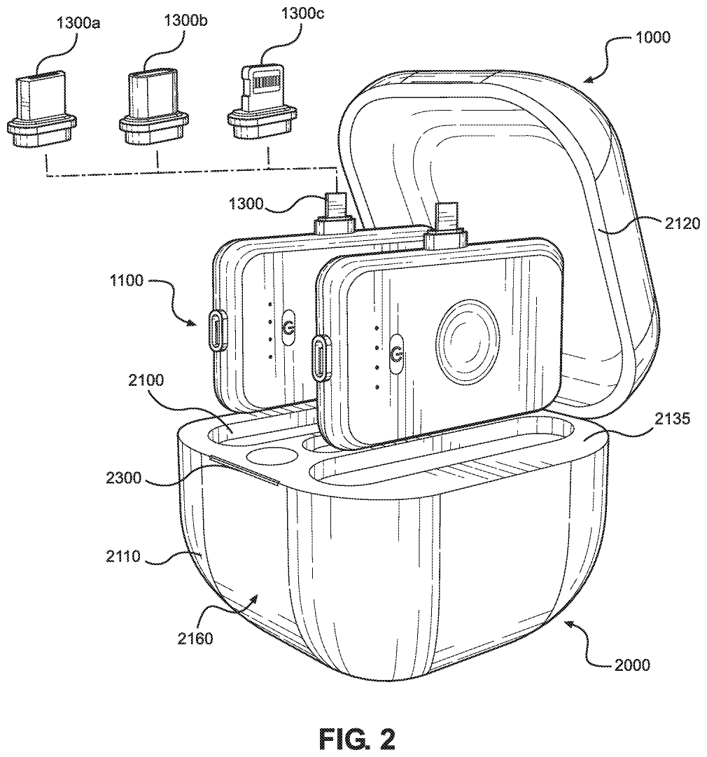

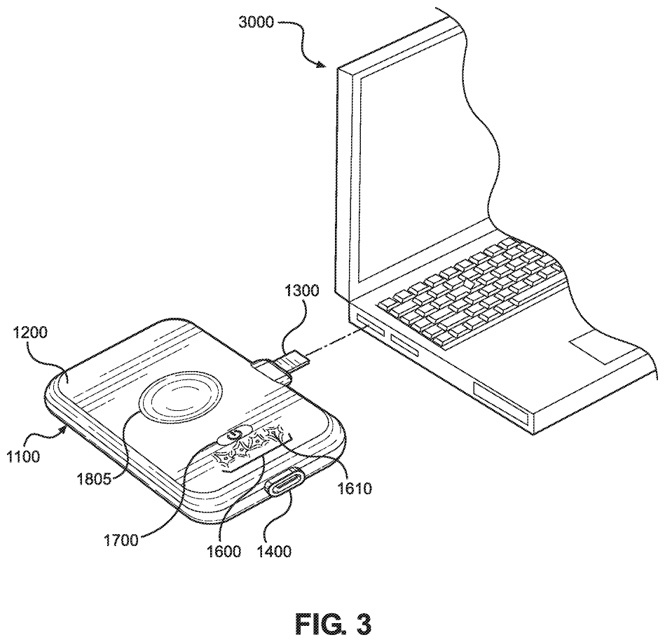

Referring now to FIGS. 1 and 2, there is shown a perspective view of an embodiment of a wireless charging case for protecting, transporting, and charging a wireless pairable charging device and perspective view of an embodiment of the wireless charging system, wherein a wireless charging case receiving a wireless pairable charging device, respectively. In the shown embodiment, the wireless charging system 1000 comprises a wireless charging case 2000 for protecting, transporting, and charging a wireless pairable charging device 1100. The wireless charging case 2000 provides for wireless charging of the wireless pairable charging device 1100, which in turn provides wireless charging of a portable electronic device 3000 (as shown in FIG. 3), such as a laptop, smart phone, tablet, and the like.

In the shown embodiment, the wireless charging case 2000 comprises a housing 2110 having a lid 2120 hingedly secured to an upper end of the housing 2110. The lid 2120 is configured to pivotally rotate away from the housing 2110, such that an interior of the housing 2110 is exposed and reveals one or more slots 2100. The lid 2120 is adapted to selectively transition between a closed position where the lid 2120 conceals the wireless pairable charging device 1100 within the wireless charging case 2000 and an open position where the lid 2120 is displaced from the housing 2110 such that a user can remove the wireless pairable charging device 1100 from the case 2000.

In the shown embodiment, the housing 2110 includes an inner member 2130 having an upper side 2135 that forms a continuous surface with the exterior of the housing 2110 when the lid 2120 is in an open position. The upper side 2135 includes the pair of slots 2100. Each slot 2100 is configured to receive therein the wireless pairable charging device 1100. Moreover, each slot 2100 is configured to inductively charge the wireless pairable charging device 1100 when it is inserted into the slot 2100. In the shown embodiment, the one or more slots 2100 comprise a pair of slots 2100 disposed parallel to each other and disposed on opposing lateral sides of the housing 2110.

In the illustrated embodiment, the lid 2120 and the housing 2110 each comprise one or more mating fasteners for securing the lid 2120 in the closed position. The one or more mating fasteners include a set of paired magnets 2300 disposed opposite one another, such that when the lid 2120 is in contact with the housing 2110, the lid 2120 remains closed and does not rotate without the forceable input of the user.

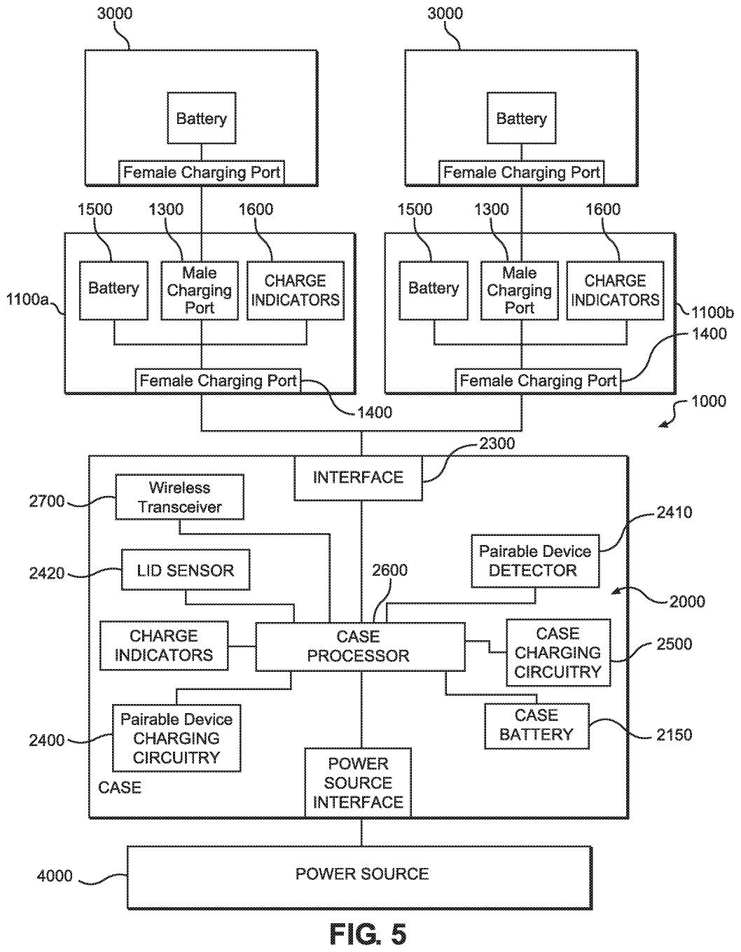

The housing 2110 includes a case power source interface 2160 (shown in FIG. 5) accessible from an outer side of the housing 2110. The case power source interface 2160 is configured to receive an electrical connector from a cable, such that the case power source interface 2160 is operably connected to a case battery 2150 (shown in FIG. 5) disposed within the housing 2110. In this way, when the cable is connected to a power source, such as a wall outlet, and the electrical connector is connected to the case power source interface 2160, the case battery 2150 within the housing 2110 is being charged.

In the shown embodiment, the inner member 2130 of the housing 2110 additionally includes an indentation 2140. In the illustrated embodiment, the indentation 2140 is disposed in the center of the inner member 2130, such that it is disposed between the pair of slots 2100. In this way, the indentation 2140 aids the user in removing the wireless pairable charging device 2000 from the slots 2100, when the wireless pairable charging device 2000 is placed within the slot 2100.

In the shown embodiment, the wireless pairable charging device 1100 comprises a male charging port 1300 disposed on a side of a body 1200 of the wireless pairable charging device 1100. In one embodiment, the male charging port 1300 is permanently affixed to the body 1200 and operably connected to the battery of the wireless pairable charging device 1100. The male charging port 1300 may be selected from Mini USB, 1300a, USB Type-C 1300b, MICRO USB 1300c, the like. However, in alternative embodiments, the male charging port 1300 is adapted to be removably connected to the body 1200 such that any compatible male charging ports 1300a-c is interchangeable with the existing male charging ports 1300. Thereby, a user may selectively change the male charging port 1300 for charging difference electronic devices having different input interfaces or connectors. In one embodiment, the wireless pairable charging device 1100 is adapted to detect the presence and removal of each type of male charging ports 1300a-c and adjust the electrical out accordingly.

As shown in the embodiment of FIG. 2, the wireless pairable charging device 1100 are received within the one or more slots 2100, respectively. The wireless pairable charging device 1100 are shown as being positionable within the slots 2100 such that the female charging port 1400 is facing a front of the case 2000 and the male charging port 1300 is facing a top of the case 2000. The slots 2100 include a pair of slots that are parallel and extend between the front and rear of the case 2000. In alternative embodiment, the slots 2100 may be oriented in any manner, such as extending between the left and right lateral sides of the case 2000. In another embodiment, the wireless pairable charging device 1100 may be positioned within the slots 2100 in any other orientation. For example, in one embodiment, the slots 2100 extend between the left and right lateral sides of the case 2000 and the female charging port 1400 is facing the bottom of the case 2000 and the male charging port 1300 is facing the left lateral sides of the case 2000.

Referring now to FIG. 3, there is shown a perspective view of an embodiment of a wireless pairable charging device being connected to a portable electronic device. In the shown embodiment, the wireless pairable charging device 1100 comprises a male charging port 1300 disposed on a side of a body 1200 of the wireless pairable charging device 1100. The male charging port 1300 is adapted to removably insert into the portable electronic device 3000 and provide electrical charge to the portable electronic device 3000 via a rechargeable battery 1500 (shown in FIG. 5) disposed within the body 1200.

In the illustrated embodiment, the male charging port 1300 is configured to removably insert into an iPhone, iPod, or other similar device. However, in other embodiments, the male charging port 1300 is configured to removably insert into other electronic devices, such as a laptop or an Android phone. In one embodiment, the male charging port 1300 is selected from at least a USB TYPE-C connector and a lighting port connector. In the shown embodiment the male charging port 1300 is disposed on one of the four sides of the body 1200, such that a protrusion extends from one side of the body 1200 and the male charging port 1300 is disposed therein. In this way the protrusion provides additional structural integrity to the male charging port 1300.

In the shown embodiment, a female charging port 1400 is operably connected to the rechargeable battery 1500 and disposed on a side of the body 1200. The female charging port 1400 is configured to operably connect to a charging connector and thereby charge the rechargeable battery 1500. In one embodiment, the female charging port 1400 is adapted to engage with a wireless charging contact 2300 (shown in FIG. 5) of the wireless charging case 2000.

In the illustrated embodiment, the female charging port 1400 is disposed on a side of the body 1200 different from the position of the male charging port 1300, such that the male charging port 1300 and female charging port 1400 are not disposed on the same side of the body 1200. In this way, the user can recharge the pairable charging device 1100 through the female charging port 1400 while simultaneously charging their device using the male charging port 1300. In the illustrated embodiment, the male charging port 1300 and the female charging port 1400 are disposed perpendicular to one another, however in other embodiments they may also be disposed opposite one another.

In the shown embodiment, the pairable charging device 1100 comprises a body 1200 having a rectangular shape, such that the body 1200 includes two faces disposed opposite one another and four sides disposed perpendicular to one another and connecting the two faces.

In one embodiment, the wireless pairable charging device 1100 comprises a charge display or indicators 1600 operably connected to the rechargeable battery 1500, comprising a series of lights 1610 disposed on one of the faces of the body 1200, configured to correspondingly display the remaining charge in the rechargeable battery 1500. A remaining charge button 1700 is operably connected to the charge display 1600, such that when the remaining charge button 1700 is actuated the charge display 1600 is activated.

In one embodiment, the remaining charge display 1600 comprises four discrete lights 1610, each of which correspond to an indication of 25% of the total battery charge of the rechargeable battery 1500 (i.e. in the illustrated embodiment, four lights indicates 100% charge, while three lights indicate 75% charge, etc.). The charge display 1600 is in communication with the charge button 1700, such that when the charge button 1700 is depressed, the lights in the remaining charge display 1600 are activated, thereby allowing the user to view how much of the battery charge remains in the device 1100.

In the illustrated embodiment, the body 1200 includes a depression 1800 in the center of a front face of the body 1200. The depression 1800 provides tactile feedback for the user, thereby allowing them to easily grasp and hold the body 1200. In the illustrated embodiment, the depression 1800 is additionally emblazoned with an image.

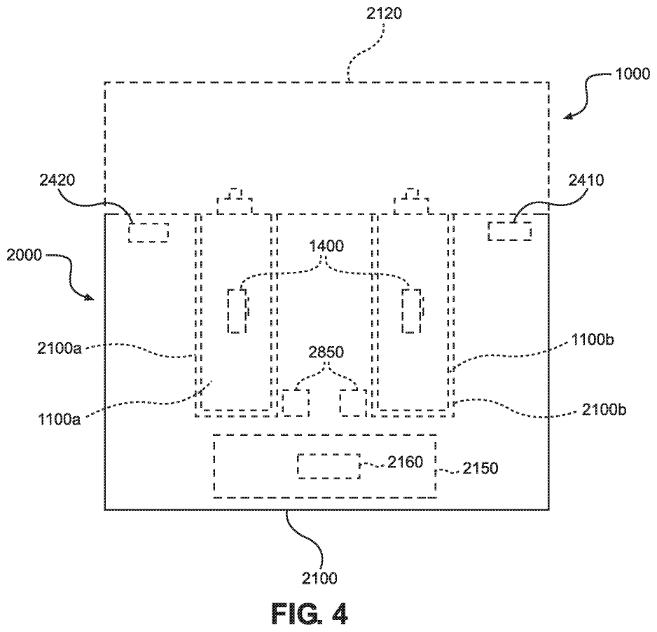

Referring now to FIGS. 4 and 5, there is shown a transparent side view and a block diagram of an embodiment of the wireless pairable charging device disposed within the wireless charging case, respectively. In the shown embodiment of the wireless charging system 1000, the wireless pairable charging devices 1100a, 1100b are received within the slots 2100a, 2100b of the wireless charging case 2000 and operably connected therewith via the wireless charging contact. In one embodiment, the wireless charging case 2000 comprises an interface for electronically coupling the wireless charging case 2000 to the wireless pairable charging devices 1100a, 1100b. The interface includes a wireless charging contact 2850 configured to couple the wireless pairable charging devices 1100a, 1100b to the case 2000 when at least one of the wireless pairable charging devices 1100a, 1100b are placed within the housing 2110. In the shown embodiment, the female charging ports 1400 of each of the wireless pairable charging devices 1100a, 1100b are in wireless electronic communication with the interface.

In the shown embodiment, the wireless charging case 2000 comprises wireless pairable charging device charging circuity 2400 having a wireless pairable device detector 2410 and a lid sensor 2420. The charging circuitry 2400 is configured to initiate charging of the wireless pairable charging device when the detector 2410 detects that the wireless pairable charging device is inserted into the one or more slots 2100 and when the lid sensor 2420 detects the lid 2120 is in the closed position.

In the shown embodiment, the wireless charging case 2000 further comprises case charging circuitry 2500 configured to charge the case battery 2150 via a power source interface 2160. In one embodiment, the power source interface 2160 comprises an electrical connector adapted to connect to an external power source 4000 such as an electrical wall outlet or external battery.

The wireless charging case 2000 further comprises a case processor 2600 adapted to control the wireless charging case 2000. The wireless charging case 2000 further comprises data communications circuitry configured to transmit firmware data and charging data to a portable electronic device 3000. In one embodiment, the charging data includes information such as amount of charge remaining in the case battery 2150, predictive time to full charge of the wireless pairable charging devices 1100, the wireless charging case 2000, and/or the portable electronic device 3000.

The wireless charging case 2000 further comprises wireless communication circuitry operably configured to transmit charging data of the case battery 2150. In one embodiment, the wireless communication circuitry includes a wireless transceiver 2700. In one embodiment, the wireless communication circuitry is operably configured to transmit charging data of the rechargeable batteries of each of the wireless pairable charging device 1100a, 1100b.

In one embodiment, the wireless communication circuitry of the wireless case 2000 is adapted to communicate with a companion electronic device 5000 to transmit battery charge information, such as charge state (charging, not charging, etc.), number of wireless pairable charging devices 1100 operably connected thereto, charge amount, and the like. In one embodiment, the wireless pairable charging device 1100 includes wireless communication circuitry adapted to communicate with a companion electronic device 5000 to transmit battery charge information.

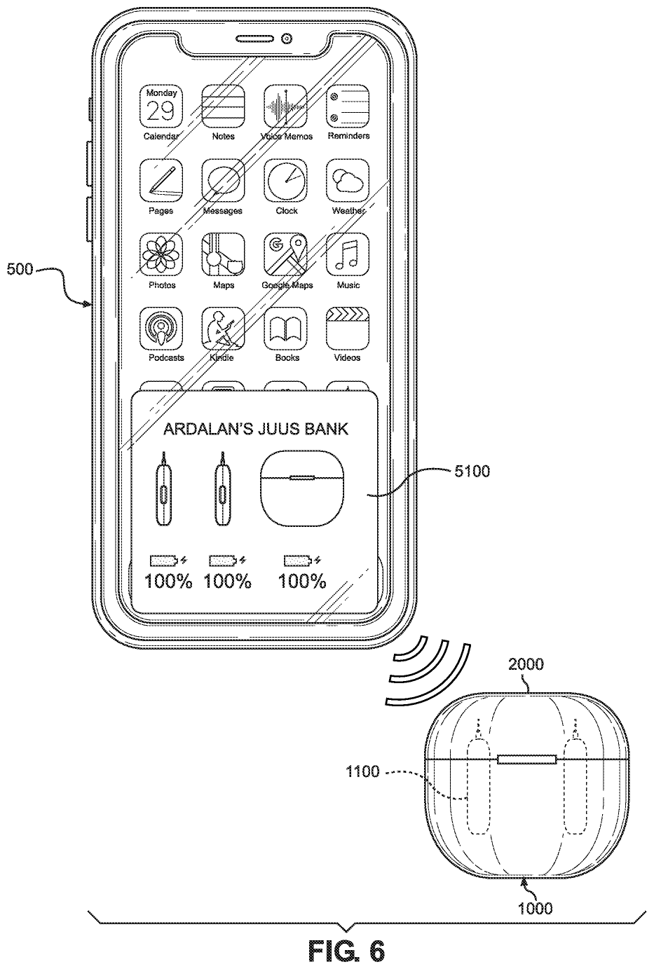

Referring now to FIG. 6, there is shown a front view of one embodiment of a graphical user interface of a companion electronic device operably connected to the wireless pairable charging device and the wireless charging case. In one exemplary embodiment of using the wireless pairable charging device 1100 to charge a portable electronic device 3000, a user selectively removes one of the wireless pairable charging devices 1100 from the wireless case 2000 by lifting the lid 2150 and removing the wireless pairable charging device 1100 from the charging slot 2100. The pairable charging device 1100 is subsequently inserted into the portable electronic device 3000 to provide a charge. In one embodiment, the wireless pairable charging devices 1100 transmits charging data and firmware data of the wireless charging case battery to the portable electronic device 3000 to allow efficient charging thereof.

After the charge has been delivered to the portable electronic device 3000, the wireless pairable charging devices 1100 is returned to the wireless case 2000. In one embodiment, the wireless charging case 2000 and/or the wireless pairable charging devices 1100 are in wireless communication with the companion electronic device 5000. In one embodiment, the portable electronic device 3000 is the same as the companion communication device 5000. In alternative embodiments, the portable electronic device 3000 is distinct from the companion communication device 5000. In the shown embodiment, the companion communication device 5000 is a smart phone that is not coupled to the wireless pairable charging devices 1100. In other embodiments, the companion communication device 5000 may be another smartphone, tablet, or any electronic device adapted for electronic communication and having a display.

The user can selectively choose to display a graphical user interface (GUI) 5100 on the communication device 5000. In the illustrated embodiment, the GUI 5100 displays the pairable charging device battery information and the case battery information. In this way, the user can conveniently determine: the number of wireless pairable charging devices 1100 charging via the wireless charging case 2000, charging data of each rechargeable battery of the wireless pairable charging devices 1100 and/or the case battery of the wireless charging case 2000. This may include information such as predictive time to full charge of the wireless pairable charging devices 1100, the wireless charging case 2000, and/or the portable electronic device.

In one embodiment, the wireless charging case comprises a charge display or indicators operably connected to the case battery 2150, comprising a series of lights disposed on the housing 2110 configured to correspondingly display the remaining charge in the case battery 2150. A remaining charge button is operably connected to the charge display of the wireless charging case, such that when the remaining charge button is actuated the charge display is activated.

In one embodiment, the charge display of the case comprises four discrete lights, each of which correspond to an indication of 25% of the total battery charge of the case battery (i.e. in one embodiment, four lights indicates 100% charge, while three lights indicate 75% charge, etc.). The charge display is in communication with the charge button, such that when the charge button is depressed, the lights in the remaining charge display are activated, thereby allowing the user to view how much of the battery charge remains in the case 2000.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wireless charging case for protecting, transporting, and charging a wireless pairable charging device that includes a rechargeable battery, comprising:
a housing configured to receive one or more of the wireless pairable charging devices;
wherein the housing comprises an upper surface having one or more slots adapted to receive the wireless pairable charging device, the one or more slots disposed in an interior of the housing;
a lid attached to the housing and operable between a closed position where the lid conceals the wireless pairable charging device within the wireless charging case and an open position where the lid is displaced from the housing such that a user can remove the wireless pairable charging device from the case;
a wireless charging contact configured to couple to the wireless pairable charging device when the wireless pairable charging device is placed within the housing;
wherein the housing comprises mating fasteners for securing the lid in the closed position;
wherein each slot is adapted to inductively charge the wireless pairable charging device received therein;
a wireless charging case battery;
a wireless communication circuitry operably configured to transmit charging data of the wireless charging case battery.

2. The wireless charging case of claim 1, wherein the wireless communication circuitry operably configured to transmit charging data of the rechargeable batteries of each of the wireless pairable charging device.

3. The wireless charging case of claim 2, further comprising a first plurality of charge level indicators that visually indicate a charge level of the case battery disposed within the case and a second plurality of charge level indicators that visually indicate a charge level of one or more rechargeable batteries within the wireless pairable charging device.

4. The wireless charging case of claim 3, wherein the second plurality of charge level indicators comprises four lights that activate in fixed sequential order to indicate a charge level of one or more rechargeable batteries within the wireless pairable charging device.

5. The wireless charging case of claim 1, further comprising a connector configured to interface with a power source that supplies power to the housing to charge the wireless charging case battery.

6. The wireless charging case of claim 1, wherein the housing further comprises charging circuitry configured to initiate charging of the wireless pairable charging device when a detector detects that the wireless pairable charging device is inserted into the one or more slots and a lid sensor detects the lid in the closed position.

7. The wireless charging case of claim 1, wherein the housing comprises a power button operably connected to charging circuitry configured to initiate charging of the wireless pairable charging device when a detector detects that the wireless pairable charging device is inserted into the one or more slots and the power button is actuated.

8. The wireless charging case of claim 1, further comprising an electrical connector adapted to charge the wireless charging case battery.

9. The wireless charging case of claim 1, wherein the wireless communication circuitry is adapted to communicate with a companion electronic device to transmit battery charge information.

10. The wireless charging case of claim 9, wherein the battery charge information includes charge state and a number of wireless pairable charging devices operably connected to the wireless charging case.

11. A wireless pairable charging device, comprising:
a body having a rechargeable battery disposed therein;
a male charging port operably connected to the rechargeable battery and disposed on a side of the body, the male charging port adapted to removably insert into a portable electronic device and provide electrical charge to the portable electronic device;
a female charging port operably connected to the rechargeable battery and disposed on a side of the body, the female charging port configured to operably connected to a charging connector and thereby charge the rechargeable battery.

12. The wireless pairable charging device of claim 11, further comprising:
a charge display operably connected to the battery, comprising a series of lights disposed on one of the faces of the body, configured to correspondingly display the remaining charge in the battery;
a remaining charge button operably connected to the charge display, such that when the remaining charge button is depressed the charge display is activated.

13. The wireless pairable charging device of claim 11, wherein the body comprises a rectangular shape with four sides disposed perpendicular to one another affixed to two faces disposed opposite one another.

14. The wireless pairable charging device of claim 11, wherein the male charging port is selected from at least a USB TYPE-C connector and a lighting port connector.

15. The wireless pairable charging device of claim 11, further comprising wireless communication circuitry operably configured to transmit charging data of the rechargeable battery to a companion electronic device.

16. The wireless pairable charging device of claim 15, wherein the wireless communication circuitry is adapted to communicate with a companion electronic device to transmit battery charge information, wherein the battery charge information includes charge state of the rechargeable battery and a number of wireless pairable charging devices operably connected to the wireless charging case.

17. A wireless charging system for protecting, transporting, and charging a wireless pairable charging device that includes a rechargeable battery, and for charging a portable electronic device from the wireless pairable charging device, comprising:
a wireless charging case, comprising:
a housing configured to receive one or more of the wireless pairable charging device;
wherein the housing comprises an upper surface having one or more slots adapted to receive the wireless pairable charging device, the one or more slots disposed in an interior of the housing;
a lid attached to the housing and operable between a closed position where the lid conceals the wireless pairable charging device within the wireless charging case and an open position where the lid is displaced from the housing such that a user can remove the wireless pairable charging device from the case;
a wireless charging contact configured to couple to the wireless pairable charging device when the wireless pairable charging device is placed within the housing;
wherein each slot is adapted to inductively charge the wireless pairable charging device received therein;
a wireless charging case battery;
a wireless communication circuitry operably configured to transmit charging data of the wireless charging case battery;
the wireless pairable charging device, comprising:
a body having a rechargeable battery disposed therein;
a male charging port operably connected to the rechargeable battery and disposed on a side of the body, the male charging port adapted to removably insert into a portable electronic device and provide electrical charge to the portable electronic device;
a female charging port operably connected to the rechargeable battery and disposed on a side of the body, the female charging port configured to receive a charging connector therein and thereby charge the wireless pairable charging device.

18. The wireless charging system of claim 17, wherein housing comprise a pair of mating fasteners for securing the lid in the closed position.

19. The wireless charging system of claim 17, wherein the housing further comprises charging circuitry configured to initiate charging of the wireless pairable charging device when a detector detects that the wireless pairable charging device is inserted into the one or more slots and a lid sensor detects the lid in the closed position.

20. The wireless charging system of claim 17, wherein:
the wireless charging case further comprises wireless communication circuitry operably configured to transmit charging data of the wireless charging case battery to a companion electronic device; and
the wireless pairable charging device further comprises wireless communication circuitry operably configured to transmit charging data of the rechargeable battery to the companion electronic device.
